(19) United States
(12) Patent Application Publication
(10) Pub. No.: US 2015/0100486 A1
(43) Pub. Date: Apr. 9, 2015

(54) SYSTEM AND METHOD FOR AUTOMATICALLY ENROLLNG AN ITEM IN A VIRTUAL WALLET

(71) Applicants: Sydney Green, San Francisco, CA (US); Robert Alandt, San Mateo, CA (US); Paul Spaeth, Half Moon Bay, CA (US); Kevin Wong, Sausalito, CA (US)

(72) Inventors: Sydney Green, San Francisco, CA (US); Robert Alandt, San Mateo, CA (US); Paul Spaeth, Half Moon Bay, CA (US); Kevin Wong, Sausalito, CA (US)

(21) Appl. No.: 14/507,593

(22) Filed: Oct. 6, 2014

Related U.S. Application Data
(60) Provisional application No. 61/887,228, filed on Oct. 4, 2013.

(51) Int. Cl. G06Q 20/36; G06Q 20/28; G06Q 20/22

(52) U.S. Cl. CPC G06Q 20/36; G06Q 20/227; G06Q 20/28
USPC 705/41

(57) ABSTRACT

Systems and methods for enrolling one or more items into a virtual wallet are provided. A transaction message for a transaction is received. The transaction message includes information associated with the one or more items and a primary payment card associated with a user. The information associated with the one or more items is enrolled into the virtual wallet associated with a user. The virtual wallet includes information associated with a primary payment account associated with the user.

### CROSS-REFERENCES TO RELATED APPLICATIONS

This application is a non-provisional application of and claims the benefit of priority to U.S. Provisional Application No. 61/887,228, filed on Oct. 4, 2013, which is herein incorporated by reference in its entirety for all purposes.

### BACKGROUND

The use of virtual wallets has gained increased attention in the last few years as an alternative to carrying around physical payment cards. Virtual wallet applications allow users to electronically store their payment card (or other card) information in a software application. Many large banks and payment providers have already implemented virtual wallet applications available for their users.

However, current virtual wallet application solutions require the user to manually enter the account information associated with the payment card into the virtual wallet application. This is a tedious task as it requires manual entry on the part of the user of each digit of the card into the virtual wallet application.

It would be desirable to provide for a virtual wallet enrollment method that can automatically enroll account information associated with a payment card into a virtual wallet application. Embodiments of the invention address this and other problems, individually and collectively.

### BRIEF SUMMARY

In some embodiments of the invention, systems and methods for enrolling one or more items in a virtual wallet are provided. The systems and methods provide convenience for consumers and reduce fraud risk for merchants and banks. Virtual wallets are typically linked to at least one primary payment card account associated with a user. A user can purchase an item (e.g., a prepaid card) at a merchant using an access device (e.g. a POS terminal). The access device may obtain information (e.g., card number, card type, PIN, etc.) pertaining to the item (e.g., prepaid card), and may generate a transaction message including this information and then transmit it to a payment processing network. The transaction message may also include transaction information including the primary account number of the payment device (e.g., a real or virtual credit card) that is being used to purchase the item. The payment processing network can identify the user's virtual wallet based on the primary account number within the transaction message. The payment processing network can automatically, or upon feedback from the user, enroll the purchased item (e.g., prepaid card) in the user's virtual wallet based on the information pertaining to the item (e.g., prepaid card) included within the transaction message. In some embodiments, the transaction message may be an ISO 8583 type message.

In some embodiments of the invention, systems and methods for transferring an enrolled item (e.g., prepaid card) from one user's virtual wallet to another user's virtual wallet are also provided. A code may be sent from a payment processing network computer to a first user's virtual wallet application on the first user's communication device (e.g., a mobile phone). The first user may provide the code to the second user. After receiving the code, the second user may enter the code into his/her virtual wallet application on the second user's communication device. Once the code has been entered, the payment processing network computer may receive a message indicating that the code has been correctly entered into the second user's virtual wallet application, and may then facilitate the transfer of the item (e.g., prepaid card) or information pertaining to the item from the first user's virtual wallet to the second user's virtual wallet. In this example, the information transferred from the first wallet to the second wallet may include account information associated with a prepaid account, which may or may not be associated with a physical prepaid card.

In some embodiments of the invention, systems and methods for enrolling one or more items in a virtual wallet using an automated teller machine (ATM) are provided. A user may swipe his/her bank card or debit card at an ATM to begin an ATM interaction. One of the ATM-provided options may be to enroll an item (e.g., prepaid card) into a virtual wallet. The user may select the option and then swipe the item (e.g., prepaid card) at the ATM. The ATM may facilitate enrollment of the item (e.g., prepaid card) into the user's virtual wallet based at least in part on information obtained from both the swipe of the bank card/debit card and the item (e.g., prepaid card).

Some embodiments of the invention are directed to a method including receiving, by a computer, a transaction message for a transaction, the transaction message including information associated with the one or more items. The method additionally includes enrolling, by the computer, the information associated with the one or more items into the virtual wallet associated with a user, wherein the virtual wallet stores information associated with a primary payment account associated with the user.

In some embodiments, wherein the one or more items comprise at least one of a payment card, a store card, a prepaid card, a gift card, a credit card, a debit card, an automated teller machine (ATM) card, a charge card, a fleet card, a driver's license, a coupon, or a rewards card. Such items may be real or virtual and may have information associated with them. Such information may include account identifiers (e.g., account numbers), verification values (CVV or dCVV values), expiration dates, and/or digital signatures.

In some embodiments, the transaction message is an authorization request message, a settlement message, or a clearing file.

In some embodiments, the method further comprises presenting, prior to enrolling the information associated with the one or more items into the virtual wallet associated with the user, the user with a prompt comprising one or more options to allow or deny enrollment of the one or more items into the virtual wallet.

In some embodiments, the transaction message is received from an access device, wherein the access device is a POS terminal or an ATM.

In some embodiments, the method further comprises updating an application associated with the virtual wallet with the information associated with the one or more items, wherein the application is executed on a communication device.

In some embodiments, the primary payment account is a first primary payment account, the user is a first user and the virtual wallet is a first virtual wallet, and the method further includes enrolling the information associated with the one or more items into a second virtual wallet associated with a second user, wherein the second virtual wallet includes information associated with a second primary payment account associated with the second user.

In some embodiments, the user did not purchase the one or more items, but received the one or more items as a gift from another user.

In some embodiments, the computer is in a payment processing network, which resides between an acquirer and an issuer.

In some embodiments, the transaction message further comprises a primary payment account number associated with the primary payment account.

Other embodiments of the invention are directed to communication devices, servers, and systems that are configured to perform the above-described methods.

These and other embodiments of the invention are described in further detail below.

### BRIEF DESCRIPTION OF THE DRAWINGS

FIG. 1 shows a block diagram of a typical transaction processing system for electronic payment transactions using issuer accounts, in accordance with some embodiments of the invention.

FIG. 2A shows a block diagram of a communication device, in accordance with some embodiments of the invention.

FIG. 2B shows a block diagram of a server computer, in accordance with some embodiments of the invention.

FIG. 3 shows a block diagram of an access device, in accordance with some embodiments of the invention.

FIG. 4 shows a flow diagram of a method of automatically enrolling an item into a virtual wallet, in accordance with some embodiments of the invention.

FIG. 5A shows a communication device informing a user of an automatic enrollment of a new payment card in a virtual wallet, in accordance with some embodiments of the invention.

FIG. 5B shows a communication device requesting whether the user wishes to enroll a new item (e.g., prepaid card) in a virtual wallet, in accordance with some embodiments of the invention.

FIG. 6 shows a flow diagram of a method of automatically enrolling a gifted item into a virtual wallet, in accordance with some embodiments of the invention.

FIG. 7 illustrates enrollment of one or more items at an ATM, in accordance with some embodiments of the invention.

FIG. 8 is a flowchart of an exemplary method for enrolling an item in a virtual wallet

FIG. 9 shows a block diagram of a computer apparatus.

### DETAILED DESCRIPTION

Embodiments are directed at systems, methods, and devices for enrolling information pertaining to one or more items in a virtual wallet. As explained above, virtual wallets can provide convenience for users as they allow for virtual “storage” of physical items (e.g., payment cards or prepaid cards) in a software application. The software application may reside locally in a user's communication device and/or in a remote server computer. When using a payment card to make an online payment, consumers often have to enter long payment card numbers, a corresponding expiration date, and a corresponding PIN or CVV number into a Web page interface. This is tedious. Virtual wallet applications have allowed users to electronically store their payment card information in a software application. While a virtual wallet application may make it easier for a user to enter payment card information when making an online payment, the user still needs to manually enter his or her payment card information into the application. This is also tedious task. Embodiments described herein allow for automatic enrollment of an item (e.g., a prepaid card) into a virtual wallet associated with a user using an existing payments infrastructure.

Prior to discussing embodiments of the invention, descriptions of some terms may be helpful in understanding embodiments of the invention.

“Authentication” is a process by which the credential of an endpoint (including but not limited to applications, people, devices, processes, and systems) can be verified to ensure that the endpoint is who they are declared to be.

An “original” transaction may include any transaction including an authorization provided by an issuer or an authorization provided on-behalf-of an issuer.

A “substitute” transaction may be any transaction that is associated with an original transaction and that takes place after the original transaction, including repeat, refunds, reversals or exceptions (chargebacks, re-presentments, etc.).

An “end-user” may include any application, device, consumer, or system that is configured to interact with a requestor for tokenization/de-tokenization/token management services. For example, an end-user may include a consumer, a merchant, a mobile device, or any other suitable entity that may be associated with a requestor in the network token system.

A “consumer” may include an individual or a user that may be associated with one or more personal accounts and/or consumer devices. The consumer may also be referred to as a cardholder, accountholder, or user.

A “card-on-file (COF)” holder may include any entity that stores account details (e.g., card details, payment account identifiers, PANs, etc.) for use in transactions. For example, a COF entity may store payment information on file for various types of periodic payments such as monthly utility payments, periodic shopping transactions, or any other periodic or future transaction. Because payment credentials and/or associated tokens are stored at an entity for a future transaction, the transactions initiated by a COF entity include card-not-present (CNP) transactions. Another type of card-not-present (CNP) transaction includes e-commerce or electronic commerce transactions that are initiated between remote parties (e.g., a consumer device and a merchant web server computer).

An “authorization request message” may be an electronic message that is sent to a payment processing network and/or an issuer of a payment account to request authorization for a transaction. An authorization request message is an example of a transaction message. An authorization request message according to some embodiments may comply with ISO 8583, which is a standard for systems that exchange electronic transaction information associated with a payment made by a consumer using a payment device or a payment account. In some embodiments of the invention, an authorization request message may include a payment token (e.g., a substitute or pseudo account number), an expiration date, a token presentment mode, a token requestor identifier, an application cryptogram, and an assurance level data. The payment token may include a payment token issuer identifier that may be a substitute for a real issuer identifier for an issuer. For example, the real issuer identifier may be part of a BIN range associated with the issuer. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message generated by an issuing financial institution or a payment processing network. The authorization response message may include an authorization code, which may be a code that a credit card issuing bank returns in response to an authorization request message in an electronic message (either directly or through the payment processing network) to the merchant's access device (e.g. POS terminal) that indicates approval of the transaction. The code may serve as proof of authorization. As noted above, in some embodiments, a payment processing network may generate or forward the authorization response message to the merchant.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer.

An “access device” can include a device that allows for communication with a remote computer, and can include a device that enables a customer makes a payment to a merchant in exchange for goods or services. An access device can include hardware, software, or a combination thereof. Example of access devices include point-of-sale (POS) terminals, mobile phones, laptop or desktop computers, etc.

A “virtual wallet” or “digital wallet” refers to an electronic device that allows an individual to make electronic commerce transactions. This can include purchasing items on-line with a computer or using a communication device (e.g., smartphone) to purchase an item at a physical store. The “virtual wallet” or “digital wallet” can consist of the system (the electronic infrastructure), the application (the software that operates on top), and the device (the individual portion). An individual's bank account can also be linked to the virtual wallet. The individual may also have their driver's license, health card, loyalty card(s), and other ID documents stored within the virtual wallet.

A “virtual wallet provider” or “digital wallet provider” may include any suitable entity that provides a virtual wallet service or digital wallet service. A virtual wallet provider may provide software applications that store account numbers, account numbers including unique identifiers, or representations of the account numbers (e.g., tokens), on behalf of an account holder to facilitate payments at more than one unrelated merchant, perform person-to-person payments, or load financial value into the virtual wallet.

“Contactless” or “wireless” can include any communication method or protocol, including proprietary protocols, in which data is exchanged between two devices without the need for the two devices to be physically coupled. For example, “contactless” or “wireless” can include radio frequency (RF), infrared, laser, or any other communication means, and the use of any protocols, such as proprietary protocols, with such communication means.

A “prepaid card” can include closed system prepaid card and semi-closed system prepaid cards. Closed system prepaid cards are cards issued by a merchant and may only be redeemed for purchases from the merchant. They are typically of fixed amounts and are commonly known as merchant gift cards or store cards. These cards are typically purchased to be used as gifts, and are increasingly replacing the traditional paper gift certificate. Semi-closed system prepaid cards are similar to closed system prepaid cards. However, cardholders are permitted to redeem the cards at multiple merchants within a geographic area. These types of cards are issued by a third party, rather than the retailer who accepts the card. Examples include university cards and mall gift cards.

### I. Exemplary Systems

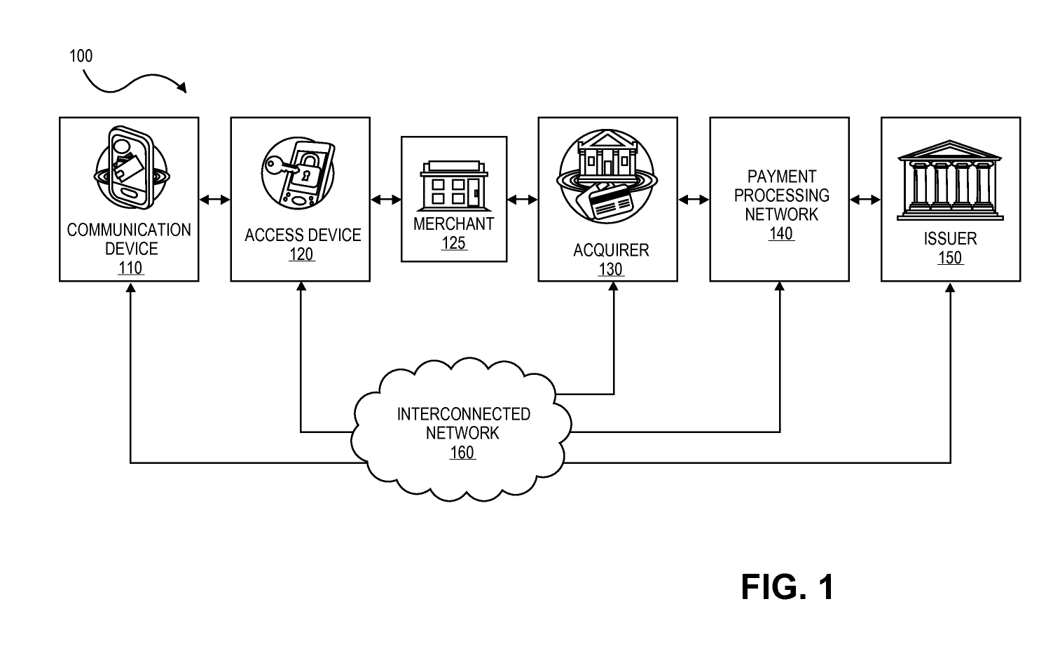

FIG. 1 shows a block diagram of a typical transaction processing system 100 configured to use real issuer identifiers (e.g., bank identification numbers (BINs)) to route authorization request messages during transaction processing. For example, payment credentials issued for consumers may include real issuer identifiers (e.g., BINs) that may be used to identify the issuer (and payment processing network) associated with the account being used to initiate the transaction.

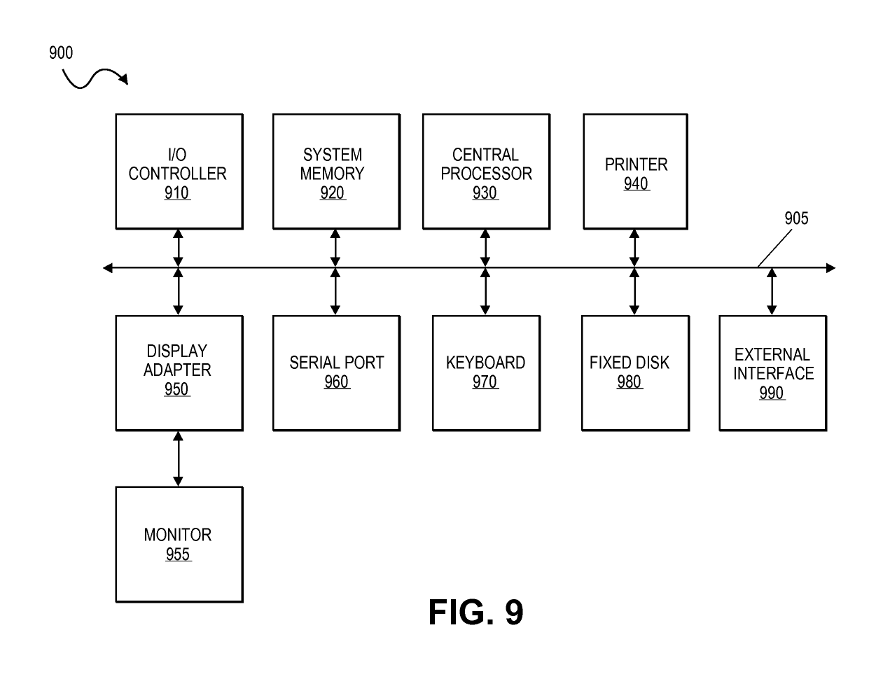

The system 100 may include a communication device 110, an access device 120, a merchant computer 125, an acquirer computer 130, a payment processing network computer 140, and an issuer computer 150. In some implementations, different entities in FIG. 1 may communicate with each other using one or more communication networks such as the Internet, a cellular network, a TCP/IP network or any other suitable communication network. Note that one or more entities in the system 100 may be associated with a computer apparatus that may be implemented using some of the components as described with reference to FIG. 9.

The communication device 120 may be associated with a payment account of a user. In some implementations, the communication device 120 may be a mobile device such as a mobile phone, a tablet, a PDA, a notebook, a key fob or any suitable mobile device. For example, the communication device 120 may include a virtual wallet or a payment application that may be associated with one or more payment accounts of the user. In some implementations, the communication device 120 may be capable of communicating with the access device 120 using a short range communication technology such as NFC. For example, the communication 110 may interact with the access device 130 by tapping or waving the consumer device 120 in proximity of the access device 130. In some implementations, the communication device 120 may be a payment card such as a credit card, debit card, prepaid card, loyalty card, gift card, etc.

The access device 120 may be an access point to a transaction processing system that may comprise the acquirer computer 130, the payment processing network computer 140, and the issuer computer 150. In some implementations, the access device 120 may be associated with or operated by the merchant computer 125. For example, the access device 120 may be a point of sale device that may include a contactless reader, an electronic cash register, a display device, etc. In some implementations, the access device 120 may be configured to transmit information pertaining to one or more purchased items at a merchant 125 to an acquirer 130 or payment processing network 140. In some implementations, the access device 120 may be a personal computer that may be used by the user to initiate a transaction with the merchant computer 125 (e.g., an online transaction).

The merchant computer 125 may be associated with a merchant. In some embodiments, the merchant computer 125 may be associated with a card-on-file (COF) merchant. For example, the card-on-file merchant may store consumer account information on file (e.g., at a merchant database) for future payment purposes such as various types of periodic payments (e.g., monthly utilities payments). In some implementations, a consumer may register with one or more merchants for card-on-file services. The merchant computer 125 may be configured to generate an authorization request for a transaction initiated by the user using the access device 120.

The acquirer computer 130 may represent a traditional acquirer/acquirer processor. The acquirer is typically a system for an entity (e.g., a bank) that has a business relationship with a particular merchant, a wallet provider or another entity. The acquirer computer 130 may be communicatively coupled to the merchant computer 125 and the payment processing network 140 and may issue and manage a financial account for the merchant. The acquirer computer 130 may be configured to route the authorization request for a transaction to the issuer computer 150 via the payment processing network computer 140 and route an authorization response received via the payment processing network computer 140 to the merchant computer 125.

The payment processing network computer 140 may be configured to provide authorization services, and clearing and settlement services for payment transactions. The payment processing network computer 140 may include data processing subsystems, wired or wireless networks, including the internet. An example of the payment processing network computer 140 includes VisaNet™, operated by Visa®. Payment processing networks such as VisaNet™ are able to process credit card transactions, debit card transactions, and other types of commercial transactions. VisaNet™, in particular includes a Visa Integrated Payments (VIP) system which processes authorization requests and a Base II system which performs clearing and settlement services. The payment processing network computer 140 may include a server computer. In some implementations, the payment processing network computer 140 may forward an authorization request received from the acquirer computer 130 to the issuer computer 150 via a communication channel. The payment processing network computer 140 may further forward an authorization response message received from the issuer computer 150 to the acquirer computer 130.

The issuer computer 150 may represent an account issuer and/or an issuer processor. Typically, the issuer computer 150 may be associated with a business entity (e.g., a bank) that may have issued an account and/or payment card (e.g., credit account, debit account, etc.) for payment transactions. In some implementations, the business entity (bank) associated with the issuer computer 150 may also function as an acquirer (e.g., the acquirer computer 130).

The various entities in the system 100 may communicate with each other via an interconnected network 160, e.g., the Internet.

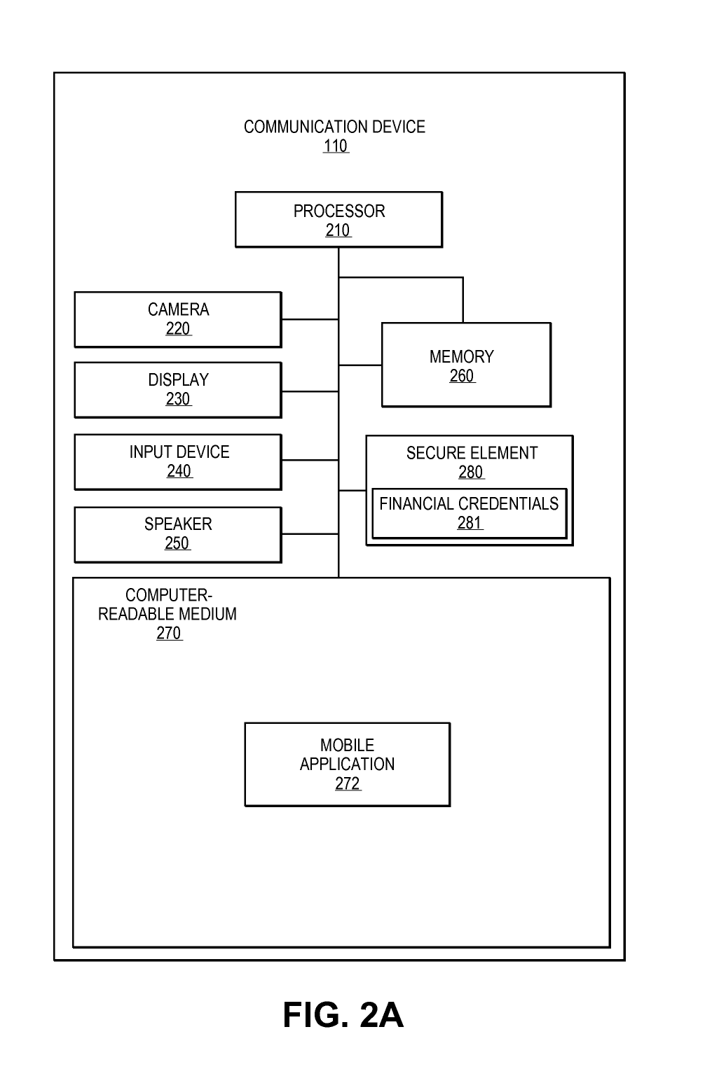

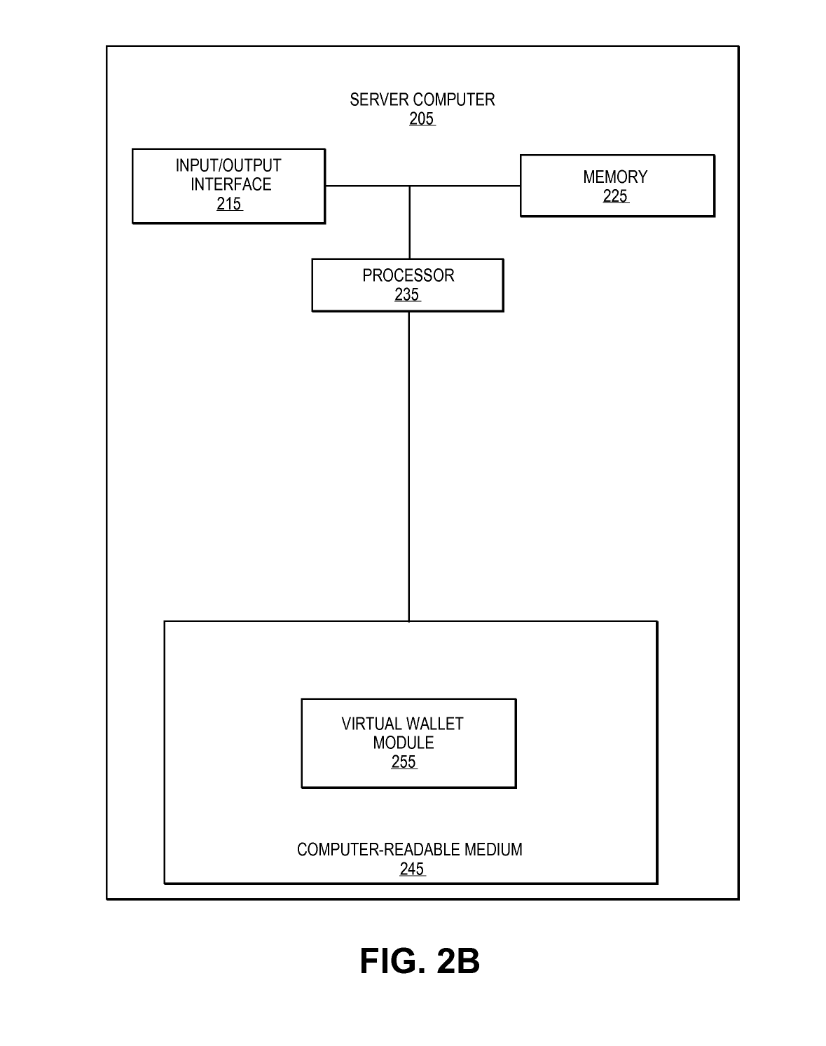

FIG. 2A shows a block diagram of a communication device 110, in accordance with some embodiments of the invention. Communication device 110 includes a processor 210, a camera 220, a display 230, an input device 240, a speaker 250, a memory 260, and a computer-readable medium 270.

Processor 210 may be any suitable processor operable to carry out instructions on the communication device 110. The processor 210 is coupled to other units of the communication device 110 including camera 220, display 230, input device 240, speaker 250, memory 260, and computer-readable medium 270.

Camera 220 may be configured to capture one or more images via a lens located on the body of communication device 110. The captured images may be still images or video images. The camera 220 may include a CMOS image sensor to capture the images. Various applications (e.g., mobile application 272) running on processor 210 may have access to camera 220 to capture images. It can be appreciated that camera 220 can continuously capture images without the images actually being stored within communication device 110. Captured images may also be referred to as image frames.

Display 230 may be any device that displays information to a user. Examples may include an LCD screen, CRT monitor, or seven-segment display.

Input device 240 may be any device that accepts input from a user. Examples may include a keyboard, keypad, mouse, or microphone. In the case of a microphone, the microphone may be any device that converts sound to an electric signal. In some embodiments, the microphone may be used to capture one or more voice segments from a user.

Speaker 250 may be any device that outputs sound to a user. Examples may include a built-in speaker or any other device that produces sound in response to an electrical audio signal. In some embodiments, speaker 250 may be used to request the user for a voice sample for purposes of authentication.

Memory 260 may be any magnetic, electronic, or optical memory. It can be appreciated that memory 260 may include any number of memory modules. An example of memory 260 may be dynamic random access memory (DRAM).

Computer-readable medium 270 may be any magnetic, electronic, optical, or other computer-readable storage medium. Computer-readable storage medium 270 includes voice data capture module 272 and voice data transmission module 274. Computer-readable storage medium 270 may comprise any combination of volatile and/or non-volatile memory such as, for example, buffer memory, RAM, DRAM, ROM, flash, or any other suitable memory device, alone or in combination with other data storage devices.

Mobile application 272 can be any application executable by processor 210 on the communication device 110. In some embodiments, the mobile application 272 can be a secure application for facilitating payment transactions using the communication device 110. For example, the mobile application 272 can be a digital wallet application. The mobile application 272 can interface with the secure element 280 to obtain the financial credentials 281 associated with the user. The mobile application 272 may contain, but is not limited to, the following core pieces: (1) a payment library including code for enabling payments including selecting and presenting the secure element 280 to the access device 120; (2) a proxy applet managed by a service provider that manages secure communications between the secure element 280 and a trusted service manager to execute account provisioning and account management commands; and (3) a contactless gateway library that includes code for enabling secure communication between the secure element 280 and a payment processor's contactless gateway.

FIG. 2B is a block diagram of a server computer 205, according to some embodiments of the present invention. Server computer 205 includes an input/output interface 215, a memory 225, a processor 235, and a computer-readable medium 245. In some embodiments, the server computer 205 may reside within the interconnected network 160 (FIG. 1). In some embodiments, the server computer 205 may reside within or be in communication with the payment processor network 140 (FIG. 1). It may alternatively or additionally be present at a merchant, issuer, or a suitable payment processor.

The input/output (I/O) interface 215 is configured to receive and transmit data. For example, the I/O interface 215 may receive an authorization request message from the acquirer 130 (FIG. 1). The I/O interface 215 may also be used for direct interaction with the server computer 205. The I/O interface 215 may accept input from an input device such as, but not limited to, a keyboard, keypad, or mouse. Further, the I/O interface 215 may display output on a display device. The I/O interface 215 may also transmit and/or receive communications from the communication device 110 (FIG. 1) or the access device 120 (FIG. 1).

Memory 225 may be any magnetic, electronic, or optical memory. It can be appreciated that memory 225 may include any number of memory modules, that may comprise any suitable volatile or non-volatile memory devices. An example of memory 225 may be dynamic random access memory (DRAM).

Processor 235 may be any suitable processor operable to carry out instructions on the server computer 300. The processor 330 is coupled to other units of the server computer 205 including input/output interface 215, memory 225, and computer-readable medium 245.

Computer-readable medium 245 may be any magnetic, electronic, optical, or other computer-readable storage medium. Computer-readable storage medium 245 includes virtual wallet module 255. Computer-readable storage medium 245 may comprise any combination of volatile and/or non-volatile memory such as, for example, buffer memory, RAM, DRAM, ROM, flash, or any other suitable memory device, alone or in combination with other data storage devices.

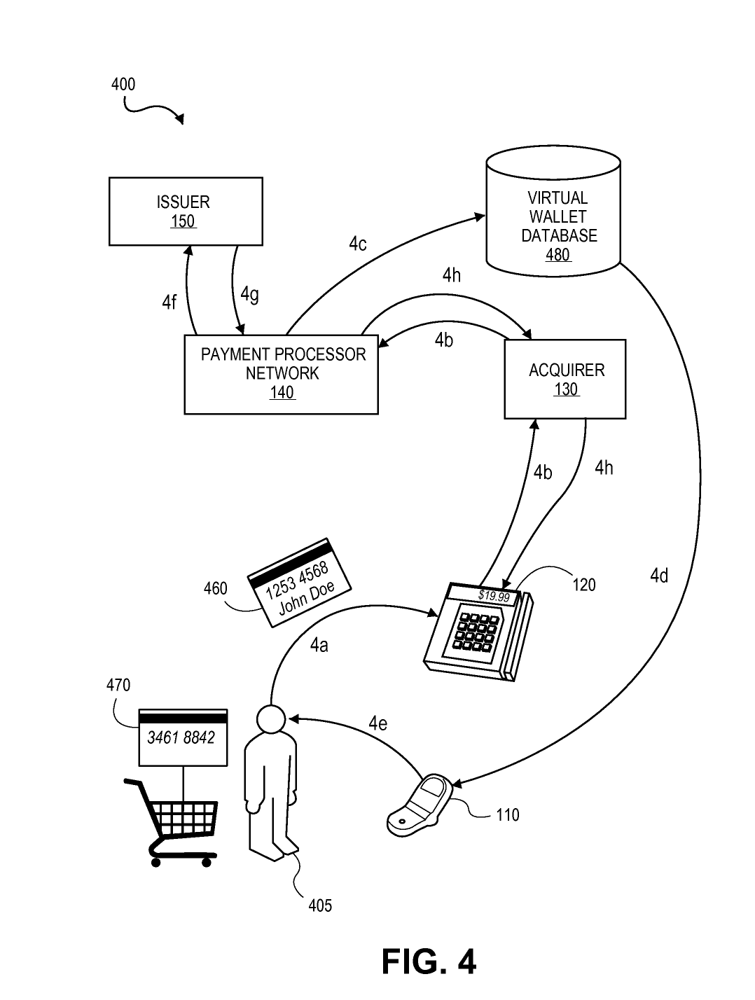

Virtual wallet module 255 can comprise code that when executed by the processor, can cause the server computer 205 to interact with a virtual wallet database 480 (see FIG. 4) that stores virtual wallet and item information pertaining to a plurality of users. Such information may include payment account credentials associated with payment cards or accounts, phone numbers, e-mail addresses, home addresses, and any other suitable information associated with a user. The virtual wallet module 255 may detect the presence of information pertaining to one or more items and information pertaining to a primary payment card or account associated with a user within a transaction message (e.g., authorization request message) received from an access device 120 (FIG. 1) or an acquirer 130 (FIG. 1). Based on the information within the transaction message (e.g., authorization request message), the virtual wallet module 255 may look up virtual wallet information pertaining to a user within the virtual wallet database. The virtual wallet module 255 can facilitate enrollment of the one or more items (e.g., information pertaining to the one or more items) within the virtual wallet database and overall virtual wallet system. Upon successful enrollment of the one or more items into the virtual wallet database, the virtual wallet module 255 may send a notification to the user's communication device via the input/output interface 215. The notification may display on the user's communication device 110 (FIG. 1) or the access device 120 (FIG. 1).

As noted above, it can be appreciated that in some embodiments the server computer 205 may reside within the payment processing network 140 (FIG. 1) or issuer 150 (FIG. 1).

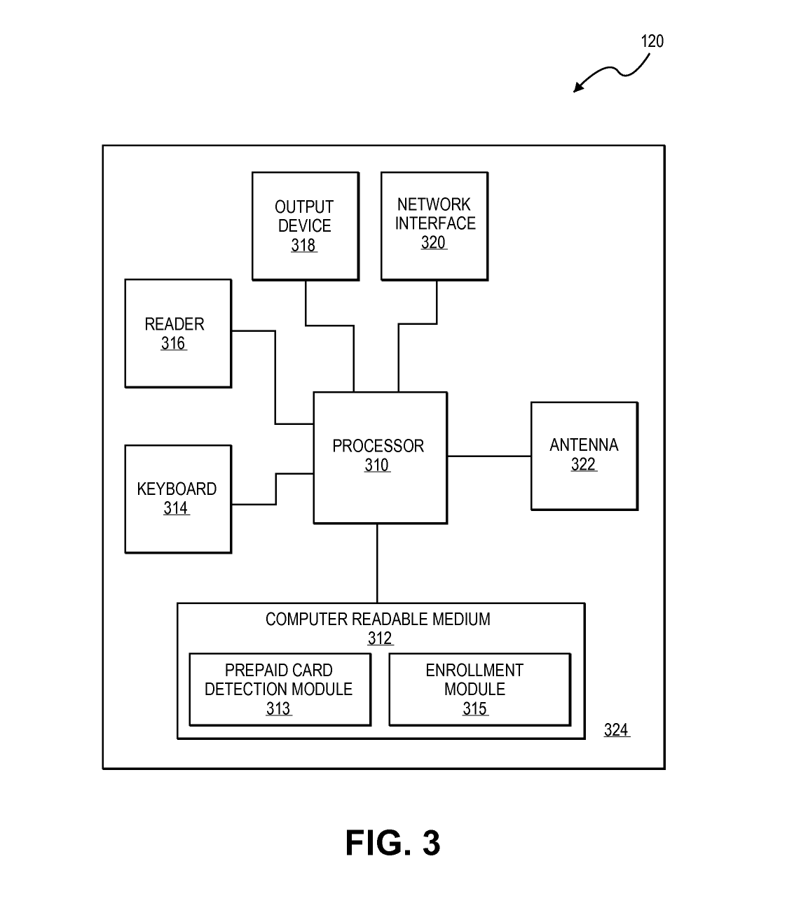

FIG. 3 shows a block diagram of an access device 120, in accordance with some embodiments of the invention. Access device 120 may comprise a processor 310. It may also comprise a computer-readable medium 312, a keypad 314, a magnetic strip reader 316, an output device 318, a network interface 320, and an antenna 322. All of these elements may be operatively coupled to processor 310. A housing 324 may also house one or more of these components. Examples of the access device 120 include, but is not limited to, a point-of-sale (POS) terminal or an automated teller machine (ATM).

Computer-readable medium 312 may include one or more memory chips, disk drives, etc. Computer-readable medium 312 may store code or instructions for allowing merchant access device 120 to operate in the manner described herein. The instructions may be executed by processor 310. Computer-readable medium 312 may store code or instructions for allowing access device 120 to operate in the manner described herein. The instructions may be executed by processor 310. Computer-readable medium 312 may further comprise any suitable modules.

Prepaid card detection module 313, in conjunction with the processor 310, may cause the access device 120 to detect an interaction (e.g., a swipe) of a prepaid card (or other item) that is being purchased. For example, if a consumer purchases a prepaid card from merchant 125 and proceeds to complete the transaction at the access device 120, the prepaid card detection module 313 may determine that the user is attempting to purchase a prepaid card. This determination can be made, for example, from data obtained by the access device 120 when a merchant employee or the user swipes the prepaid card at the access device 120. Alternatively or additionally, a clerk at the merchant 125 may enter information about the prepaid card into the access device using an input device such as a reader or keyboard.

The prepaid card can be swiped (or otherwise interact) at the access device 120 either prior or subsequent to swiping the user's payment card (or other payment device) that is being used to purchase the prepaid card. The prepaid card detection module 313, in conjunction with the processor 310, can determine that a prepaid card has been swiped based on the data obtained from the swipe, such as the card number of the prepaid card. In some cases where the prepaid card is swiped at an ATM (e.g., a non-purchase use case), the prepaid card detection module 313 can also read the prepaid card data from the swipe at the ATM.

Enrollment module 315 may be configured to facilitate enrollment of a prepaid card (or other item) into a virtual wallet. The enrollment module 315 may include data pertaining to the prepaid card in a transaction message destined for a payment processing network 140 or acquirer 130. An example of a transaction message includes, but is not limited to, an authorization request message or a settlement message. The data pertaining to the prepaid card can include, but is not limited to, the prepaid card account number, PIN, expiration date, etc. In some embodiments, the enrollment module 315 may generate the entire transaction message, while in some embodiments the enrollment module 315 may interface with another module (not shown) within the access device 120 that traditionally generates the transaction message and provide the module with the pertinent data to include in the transaction message.

Keyboard 314 may be operable to input information such as transaction information into access device 120. Magnetic strip reader 316 may be operable to read information from a magnetic strip of a card such as a credit or a debit card. Output device 318 may include a display. The display may display, for example, transaction information. Network interface 320 may be operable to enable access device 120 to communicate with other system entities. For example, it may enable access device 120 to communicate with one or more of acquirer 130, payment processing network 140, and issuer 150. Antenna 322 may be provided to enable access device 120 to operate remotely.

The systems and methods described herein with respect to enrolling one or more items in a virtual wallet can be further understood in the following illustrative examples.

### II. Automatic Item Enrollment In Virtual Wallet

FIG. 4 shows a flow diagram illustrating a method of automatically enrolling an item into a virtual wallet, in accordance with some embodiments of the invention. The method can be performed by processing logic that may comprise hardware (circuitry, dedicated logic, etc.), software (such as is run on a general purpose computing system or a dedicated machine), firmware (embedded software), multiple systems or any combination thereof.

Shown in FIG. 4, is a user 405, a communication device 110, an access device 120 (e.g., POS terminal), an acquirer 130, a payment processor network 140, a virtual wallet database 480, a primary payment card 460, a purchasable item 470 (e.g., prepaid card, store card, or other card), and an issuer 150. In some embodiments, the user 405 may wish to purchase the item 470 at the access device 120 (e.g., POS terminal) located at a merchant. For example, at step 4a, the user 105 may approach the access device 120 to complete a purchase transaction that includes the item 470 within the user's 405 shopping cart. It can be appreciated that the purchase transaction may include multiple items 470 (e.g., multiple cards) or any other items offered for sale by the merchant. The user 405 may use his/her primary payment card 460 to complete the purchase transaction. The primary payment card 460 may be associated (e.g., issued by) with the issuer 150 and already enrolled in a virtual wallet. The virtual wallet can be associated with the issuer 150, the payment processor network 140, and/or the acquirer 130. In some embodiments, the user 405 may also scan or swipe the item 470 at the access device 120, or the merchant may scan the item 470 for the user 405 using a barcode scanner, etc. Upon scanning the item 470, the access device 120 may obtain information about the item 470 via the prepaid card detection module 313 (FIG. 3), as described above.

At step 4b, the access device 120, or the merchant, may generate a purchase transaction message (e.g., authorization request message) and transmit it to the acquirer 130. The transaction message (e.g., authorization request message) may include data traditionally included in such type of message and relevant to the purchase transaction, e.g., the billing amount, account data, telephone number, SKU, shipping address, reward credentials, challenge response, etc. In some embodiments, the transaction message may also include information about the item 470 (e.g., prepaid card). This information may be loaded in the transaction message by the enrollment module 315 (FIG. 3), as described above. Upon receiving the transaction message, the acquirer 130 may perform traditional payment processing functions related to the transaction message and then forward the transaction message to the payment processor network 140.

The payment processor network 140 (via a computer within the payment processor network) may analyze the transaction message and detect that an item 470 (e.g., purchasable payment card or prepaid card) is being purchased by the user 405, based at least in part on the information pertaining the item 470 within the transaction message. The information about the purchasable item 470 (e.g., prepaid card) may include the type of card, card balance, card number, card PIN, etc.

At step 4c, the payment processor network 140 may store the information about the item 470 in a virtual wallet database 480. The virtual wallet database 480 may include virtual wallet information about a plurality of users. For each user, the virtual wallet database 480 may include information about each payment card 460 that the user has registered with a virtual wallet application (e.g., mobile application 272 (FIG. 2A)) running on the user's 405 communication device 110. In some embodiments, information about the item 470 may be stored in the same location, within the virtual wallet database 480, as information about the user's 405 primary payment card 460. For example, the computer within the payment processor network 140, upon detecting that an item 470 (e.g., prepaid card) is being purchased by the user 405, based at least in part on the information in the purchase authorization request message, may also detect (from the received transaction message) that the user's 405 primary payment card 460 used for the transaction is enrolled in the virtual wallet application and stored in the virtual wallet database 480. Based upon detecting that the user's primary payment card 460 used for the transaction is enrolled in the virtual wallet application and stored in the virtual wallet database 480, the computer within the payment processor network 140 may make an inference that the user 405 may also wish to have the item 470 (e.g., prepaid card) enrolled in the virtual wallet application. In some embodiments, if the primary payment card 460 is not detected to be enrolled in the virtual wallet application, the computer within the payment processor network 140 may inform the user 405, via communication device 110, that he/she may open a virtual wallet account using the virtual wallet application. After the information about the item 470 is stored in the virtual wallet database 480, the information about the item 470 that is in the virtual wallet database 480 can be used by the user 405 to make purchases in the future. In some embodiments, the prepaid cards being purchased can be “closed loop” prepaid cards that can only be used at specific merchants. The device that is used to purchase the prepaid cards is an “open loop” payment card or account. An “open loop” payment card or account can be one that can be used to purchase goods or services at multiple merchants.

At step 4d, the virtual wallet application running on the communication device 110 may be updated to include the item 470 (e.g., prepaid card). This may be done either actively or passively. For example, the payment processor network 440 (or computer therein) may “push” a notification to the communication device 110 that information about the user's virtual wallet, stored in the virtual wallet database 480, has been updated. The communication device 110 may then access the virtual wallet database 480 to obtain the updated information. In other embodiments, the communication device 110 may periodically access the virtual wallet database 480 to obtain the latest virtual wallet information corresponding to the user 405. In yet another embodiment, the communication device 110 may store a copy of the contents of the virtual wallet database 480 locally, and update the local copy using one of the methods described above.

At step 4e, the communication device 110 may notify the user 405 that a new item 470 (e.g., prepaid card) has been enrolled in the user's virtual wallet. The user 405 may then use the item 470 (e.g., prepaid card), via the virtual wallet application, to complete a future transaction. In some embodiments, the virtual wallet application running on the communication device 110 may request confirmation from the user 405 prior to finalizing enrollment of the item 470 (e.g., prepaid card) with the virtual wallet application.

At step 4f, the transaction message (e.g., authorization request message) may be sent from the payment processor network 140 (or computer therein) to the issuer 150. The issuer 150 may then determine if the transaction is authorized (e.g., by checking for fraud and/or sufficient funds or credit). The issuer 150 may then transmit a transaction response message (e.g., authorization response message) to the access device 120 (e.g., POS terminal) (step 4g) via the payment processing network 140 and acquirer 130 (step 4h). At the end of the day, the transaction may be cleared and settled between the acquirer 140 and the issuer 150 by the payment processing network 140. It can be appreciated that steps 4f, 4g, and 4h may be completed simultaneous to any of steps 4c-4e, described above.

It can be appreciated that while the above description exemplifies the information pertaining to the item 470 being sent in an authorization request message, the information about the items being purchased can also be sent from the merchant to the payment processor network 140 (or computer therein) and the virtual wallet database 480 in a settlement message or clearing file at the end of the day. Further, although the above flow describes the information about the item being transferred from the merchant to the virtual wallet database 480 during the authorization request message transmission, it can also occur in the authorization response transmission from the issuer back to the merchant in other embodiments of the invention.

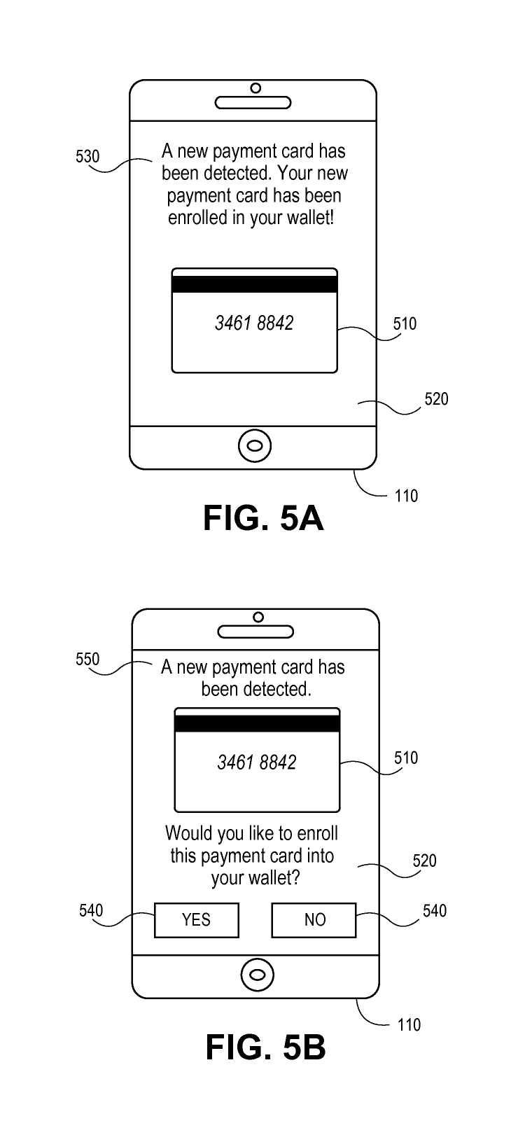

FIG. 5A shows a communication device 110 informing a user 405 (FIG. 4) of an automatic enrollment of a new payment card in a virtual wallet, in accordance with some embodiments of the invention. The communication device 110 may include a display device. The display device may display a user interface 520 and contents of the virtual wallet application running on the communication device 110. Upon enrolling a new payment card in the virtual wallet application, as described above, the communication device 110 may display a notification 530 to the user that the item 470 (FIG. 4) (e.g., prepaid card) has been enrolled in the virtual wallet application. For example, the notification 530 may read, “A new payment card has been detected. Your new payment card has been enrolled in your wallet!” Additionally, the communication device 110 may display an image 510 of the newly enrolled item 470 (FIG. 4) and details pertaining to the item (e.g., card number).

FIG. 5B shows a communication device 110 requesting whether the user wishes to enroll a new item 470 (FIG. 4) (e.g., prepaid card) in a virtual wallet, in accordance with some embodiments of the invention. FIG. 5B is similar to FIG. 5A, except that the notification 550 requests whether the user wishes to enroll the newly detected item 470 (FIG. 4) (e.g., prepaid card) in the virtual wallet application. For example, the notification 550 may read, “A new payment card has been detected. Would you like to enroll this payment card into your wallet?” The communication device 110 may also display selectable buttons 540 on the user interface 520 representing YES and NO selections for enrolling the detected item 470 (FIG. 4) (e.g., prepaid card) in the virtual wallet application. The user 450 (FIG. 4) may either confirm or deny enrollment of the newly detected item 470 (FIG. 1) (e.g., prepaid card) using the selectable buttons 540. Additionally, the communication device 110 may display an image 510 of the detected item 470 (FIG. 4), similarly as described above with respect to FIG. 5A.

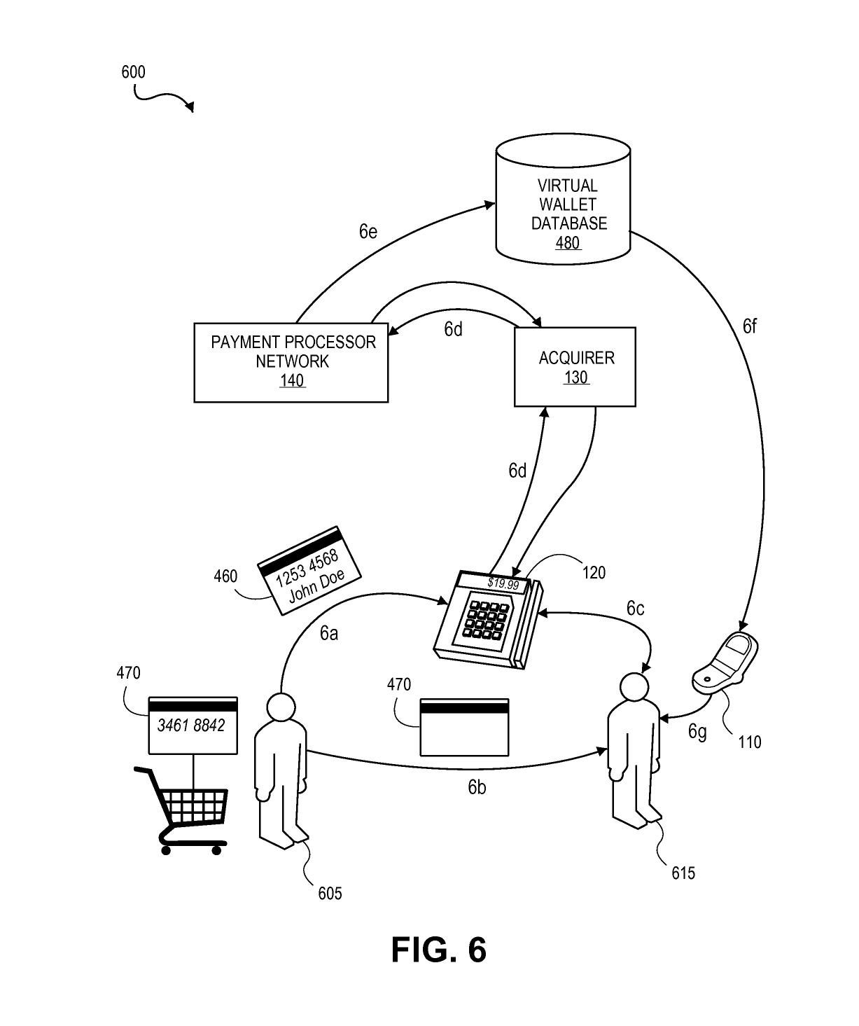

FIG. 6 shows a flow diagram of a method of automatically enrolling a gifted item into a virtual wallet, in accordance with some embodiments of the invention. The method can be performed by processing logic that may comprise hardware (circuitry, dedicated logic, etc.), software (such as is run on a general purpose computing system or a dedicated machine), firmware (embedded software), multiple systems or any combination thereof.

FIG. 6 is similar to FIG. 4 except that a first user 605 may initially purchase the item 470 and then gift or transfer the item 470 to a second user 615. The method may allow for the second user 615 to enroll the item 470 into his/her virtual wallet.

Shown in FIG. 6, is a first user 605, a second user 615, a communication device 110, an access device 120 (e.g., POS terminal), an acquirer 130, a payment processor network 140, a virtual wallet database 480, a primary payment card 460, and a purchasable item 470 (e.g., prepaid card, store card, or other card), and an issuer 150. In some embodiments, the first user 605 may wish to purchase the item 470 at the access device 120 (e.g., POS terminal) located at a merchant and then later gift or transfer the item 470 to the second user 615. For example, at step 6a, the user 105 may approach the access device 120 to complete a purchase transaction that includes the item 470 within the user's 605 shopping cart, as described above with respect to FIG. 4. Upon scanning the item 470, the access device 120 may obtain information about the item 470 via the prepaid card detection module 313 (FIG. 3), as described above.

At step 6b, the first user 605 may gift or transfer the purchased item 470 (e.g., prepaid card) to the second user 615. At step 6c, The second user 615 may then walk up to an access device 120 to begin the enrollment process of the item 470 into his/her virtual wallet. It can be appreciated that the second user 615 may enroll the item 470 into his/her virtual wallet at any time after the initial purchase by the first user 605. For example, the second user 615 may enroll the item 470 into his/her virtual wallet minutes, hours, days, weeks, or even months after the first user 605 makes the initial purchase. The second user 615 may swipe or scan the item 470 (e.g., prepaid card) at the access device 120 to begin the enrollment process. Additionally, the second user 615 may swipe his/her primary payment card enrolled in the virtual wallet at the access device 120, such that the payment processor network 140 can later identify the appropriate virtual wallet associated with the user. The second user 615 may scan or swipe (or otherwise interact) his payment card at the access device 120 either before or after scanning/swiping the item 470. It can be appreciated that the second user 615 may begin the enrollment process at an access device 120 at any merchant, and not necessarily the merchant where the item 470 was initially purchased by the first user 605. Merchants can benefit from allowing users to enroll items 470 at their locations because they may realize certain benefits from doing so (e.g., increased foot traffic at the merchant location).

At step 6d, the access device 120, or the merchant, may generate a transaction message (e.g., an enrollment request message) and transmit it to the acquirer 130, similarly as described with respect to FIG. 4. The transaction message may also include information about the item 470 (e.g., prepaid card) and the payment card belonging to the second user 615. It can be appreciated that since a purchase is not occurring at this step, the transaction message may not include any traditional purchase information. Rather, it may simply include information pertaining to the item 470 and the payment card. The amount in the authorization request may be $0 or no amount may be present. In addition, a special indicator such as an enrollment indicator may be in the authorization request so that the payment processing network can differentiate the received authorization request message from ordinary purchase authorization request messages. This information may be loaded in the transaction message by the enrollment module 315 (FIG. 3), as described above. Upon receiving the transaction message, the acquirer 130 may forward the transaction message to the payment processor network 140 (or computer therein).

The payment processor network 140 (or computer therein) may analyze the transaction message and detect that the second user 615 is attempting to enroll an item 470 (e.g., payment card or prepaid card) in a virtual wallet, based at least in part on the information pertaining to the item 470 within the transaction message. The information about the purchasable item 470 (e.g., prepaid card) may include the type of card, card balance, card number, card PIN, etc.

At step 6e, the payment processor network 140 (or computer therein) may store the information about the item 470 in a virtual wallet database 480. The virtual wallet database 480 may include virtual wallet information about the second user 615. Further, the virtual wallet database 480 may include information about one or more payment cards that the second user 615 has registered with a virtual wallet application (e.g., mobile application 272 (FIG. 2A)) running on the second user's 615 communication device 110. The payment processor network 140, upon detecting that an item 470 (e.g., prepaid card) is being enrolled by the second user 615, based at least in part on the information in the enrollment request message, may also detect that the second user's 615 primary payment card 460 is enrolled in the virtual wallet application and stored in the virtual wallet database 480. Based upon detecting that the second user's 615 primary payment card 460 used for the transaction is enrolled in the virtual wallet application and stored in the virtual wallet database 480, the payment processor network 140 may make an inference that the second user 615 may also wish to have the item 470 (e.g., prepaid card) enrolled in the virtual wallet application. In some embodiments, if the primary payment card 460 is not detected to be enrolled in the virtual wallet application, the payment processor network 140 may inform the second user 615, via communication device 110, that he/she may open a virtual wallet account using the virtual wallet application.

At step 6f, the virtual wallet application running on the second user's 615 communication device 110 may be updated to include the item 470 (e.g., prepaid card), similarly as described above with respect to FIG. 4.

At step 6g, the communication device 110 may notify the second user 615 that a new item 470 (e.g., prepaid card) has been enrolled in the user's virtual wallet. The second user 615 may then use the item 470 (e.g., prepaid card), via the virtual wallet application, to complete a future transaction.

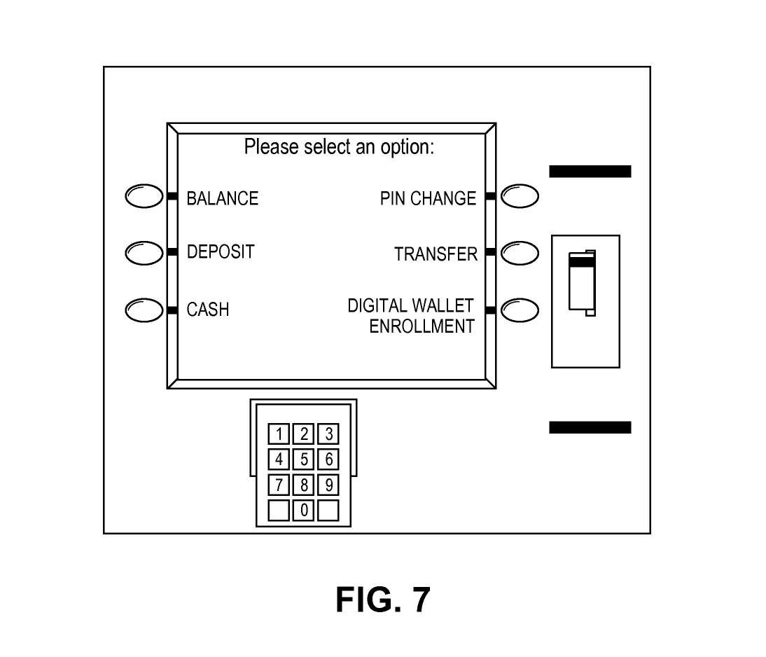

FIG. 7 illustrates enrollment of one or more items at an ATM, in accordance with some embodiments of the invention. While the above examples described enrollment of an item (e.g., prepaid card) into a virtual wallet associated with a user's primary payment card, some embodiments of the invention can allow a user to enroll one or more items at an ATM using a bank card or debit card. The bank card or debit card may already be enrolled in the user's virtual wallet. Upon obtaining an item 470 (e.g., prepaid card), a user may visit an ATM associated with their bank and swipe their bank card or debit card similar to a traditional ATM transaction.

The ATM may provide a number of options traditional options to a user (e.g., balance, deposit, cash, PIN change, transfer, etc.), in additional to an option for virtual wallet enrollment. Upon selecting the virtual wallet enrollment option at the ATM, the user may be requested to swipe his/her bank card or debit card and the item (e.g., prepaid card) the user wishes to enroll in the virtual wallet. It can be appreciated that the prompts may be presented, and the cards may be swiped, in either order. Upon swiping the item (e.g., prepaid card) and the user's bank card/debit card, the ATM may generate an enrollment request message, similarly as described with respect to FIG. 6.

The enrollment request message may be received by a server computer associated with the bank or a third-party wallet provider computer. The server computer or third-party wallet provider computer may analyze the enrollment request message to determine which virtual wallet to enroll the item (e.g., prepaid card) in, similarly as described with respect to FIG. 6. Upon successful enrollment of the item (e.g., prepaid card) in the virtual wallet, the user may be provided with a notification on the ATM screen.

In some embodiments, instead of physically gifting or transferring the item 470 to the second user 615, the first user 605 may “digitally transfer” the item 470 to the second user 615. The first user 605 may purchase the item 470 (e.g., prepaid card) using the access device 120. The item 470 (e.g., prepaid card) may be loaded into the first user's 605 virtual wallet according to steps described with respect to FIG. 4. The first user 605 may then decide to gift or transfer the item 470 (e.g., prepaid card) from his/her virtual wallet to the second user's 615 virtual wallet. In order to facilitate such a transfer, the first user 605 may interact with a virtual wallet application running on his/her communication device (not shown) and indicate that he/she wishes to transfer an item 470 from the virtual wallet to another user. The virtual wallet application may communicate with the payment processor network 140 to facilitate the transfer. Upon authenticating the first user 650, using traditional authentication techniques, the payment processor network 140 may send a unique one-time code to the virtual wallet application associated with the first user 605. The first user 605 may then view the code and provide it to the second user 615.

The second user 615 may enter the code provided by the first user 605 into a virtual wallet application running on the second user's 615 communication device 110. The virtual wallet application running on the second user's communication device 110 may then communicate with the payment processor network 140 and transmit the code entered by the second user 615. The payment processor network 140 may then verify and authenticate the second user 615 and the code, and then interact with the virtual wallet database 480 to facilitate the transfer of the item 470 (e.g., prepaid code). The payment processor network 140 may remove the item information linked to the first user 605 in the virtual wallet database 480 and link it to the second user 615 in the virtual wallet database.

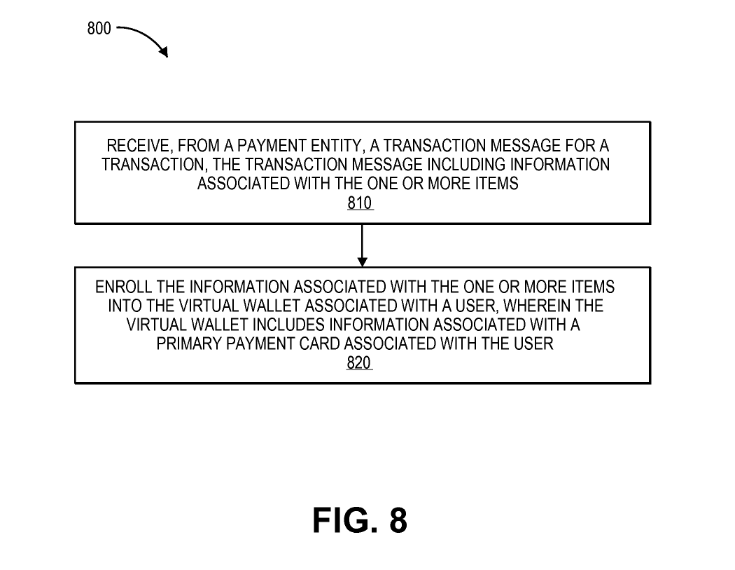

FIG. 8 is a flowchart 800 of an exemplary method for enrolling an item in a virtual wallet. The method can be performed by processing logic that may comprise hardware (circuitry, dedicated logic, etc.), software (such as is run on a general purpose computing system or a dedicated machine), firmware (embedded software), multiple systems or any combination thereof.

In block 810, a transaction message for a transaction may be received by a computer. The transaction message can include information associated with one or more items. The one or more items can include at least one of a payment card, a store card, a prepaid card, a gift card, a credit card, a debit card, an ATM card, a charge card, a fleet card, a driver's license, a coupon, or a rewards card. The transaction message can include one of an authorization request message, a settlement message, or a clearing file. The transaction message can further include a primary account number associated with a primary payment account associated with the user.

For example, in FIG. 4, the payment processor network receives, via the acquirer, a transaction message from the access device. The transaction message includes information pertaining to the user's primary payment account and the item (e.g., prepaid card). In this example, the transaction message is an authorization request message sent during the user's transaction to purchase the item (e.g., prepaid card).

In block 820, after receiving the transaction message, the information associated with the one or more items may be enrolled, by the computer, into the virtual wallet associated with the user. The virtual wallet can include information associated with a primary payment account associated with the user. In some embodiments, the user may be presented with a prompt on his/her communication device requesting verification that the user wishes to enroll the one or more items into his/her virtual wallet. In some embodiments, an application associated with the user's virtual wallet is updated with the information associated with the one or more items.

For example, in FIG. 4, virtual wallet database may be updated with the information pertaining to the item (e.g., prepaid card). Prior to updating the virtual wallet database, the user's communication device may present one or more prompts to the user seeking verification to enroll the item (e.g., prepaid card) into the virtual wallet. Upon successful enrollment of the item (e.g., prepaid card) into the virtual wallet, the virtual wallet application on the user's communication device may be updated accordingly.

In some embodiments, the first user is a first user and the virtual wallet is a first virtual wallet, the method further comprising enrolling the information associated with the one or more items into a second virtual wallet associated with the second user, wherein the second virtual wallet includes information associated with a primary payment card associated with the second user. For example, in FIG. 6, the first user may purchase the item (e.g., prepaid card) using the access device at a merchant. The user may then gift or transfer the item (e.g., prepaid card) to the second user. The second user may then interact with an access device to enroll the item (e.g.. prepaid card) into his/her virtual wallet. By swiping both his/her primary payment card and the item (e.g., prepaid card) at the access device, the payment processor network may associate the correct virtual wallet with the second user and enroll the item (e.g., prepaid card) into the virtual wallet of the second user, based at least in part on information pertaining to the primary payment card and item (e.g., prepaid card) in a transaction message (e.g., authorization request message).

The various participants and elements described herein with reference to FIGS. 1-7 may operate one or more computer apparatuses to facilitate the functions described herein. Any of the elements in FIGS. 1-7, including any servers or databases, may use any suitable number of subsystems to facilitate the functions described herein.

Examples of such subsystems or components are shown in FIG. 9. The subsystems shown in FIG. 9 are interconnected via a system bus 910. Additional subsystems such as a printer 930, keyboard 918, fixed disk 920 (or other memory comprising computer readable media), monitor 912, which is coupled to display adapter 914, and others are shown. Peripherals and input/output (I/O) devices, which couple to I/O controller 924 (which can be a processor or other suitable controller), can be connected to the computer system by any number of means known in the art, such as serial port 916. For example, serial port 916 or external interface 922 can be used to connect the computer apparatus to a wide area network such as the Internet, a mouse input device, or a scanner. The interconnection via system bus allows the central processor 928 to communicate with each subsystem and to control the execution of instructions from system memory 926 or the fixed disk 920, as well as the exchange of information between subsystems. The system memory 926 and/or the fixed disk 920 may embody a computer readable medium.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method for enrolling one or more items into a virtual wallet, comprising:
receiving, by a computer, a transaction message for a transaction, the transaction message including information associated with the one or more items; and
enrolling, by the computer, the information associated with the one or more items into the virtual wallet associated with a user, wherein the virtual wallet stores information associated with a primary payment account associated with the user.

2. The method of claim 1, wherein the one or more items comprise a prepaid card.

3. The method of claim 1, wherein the transaction message is an authorization request message, a settlement message, or a clearing file.

4. The method of claim 1, further comprising:
presenting, prior to enrolling the information associated with the one or more items into the virtual wallet associated with the user, the user with a prompt comprising one or more options to allow or deny enrollment of the one or more items into the virtual wallet.

5. The method of claim 1, wherein the transaction message is received from an access device, wherein the access device is a POS terminal or an ATM.

6. The method of claim 1, further comprising updating an application associated with the virtual wallet with the information associated with the one or more items, wherein the application is executed on a communication device.

7. The method of claim 1, wherein the primary payment account is a first primary payment account, the user is a first user and the virtual wallet is a first virtual wallet, and the method further comprises:
enrolling the information associated with the one or more items into a second virtual wallet associated with a second user, wherein the second virtual wallet includes information associated with a second primary payment account associated with the second user.

8. The method of claim 1, wherein the user did not purchase the one or more items, but received the one or more items as a gift from another user.

9. The method of claim 1, wherein the computer is in a payment processing network, which resides between an acquirer and an issuer.

10. The method of claim 1, wherein the transaction message further comprises a primary payment account number associated with the primary payment account.

11. A server computer comprising a processor, and a computer readable medium coupled the processor, the computer readable medium comprising code, executable by the processor, for implementing a method comprising:
receiving, by the server computer, a transaction message for a transaction, the transaction message including information associated with one or more items; and
enrolling, by the server computer, the information associated with the one or more items into a virtual wallet associated with a user, wherein the virtual wallet stores information associated with a primary payment account associated with the user.

12. The server computer of claim 1, wherein the one or more items comprise a prepaid card.

13. The server computer of claim 1, wherein the transaction message is an authorization request message, a settlement message, or a clearing file.

14. The server computer of claim 1, wherein the method further comprises presenting, prior to enrolling the information associated with the one or more items into the virtual wallet associated with the user, the user with a prompt comprising one or more options to allow or deny enrollment of the one or more items into the virtual wallet.

15. The server computer of claim 1, wherein the transaction message is received from an access device, wherein the access device is a POS terminal or an ATM.

16. The server computer of claim 1, wherein the method further comprises updating an application associated with the virtual wallet with the information associated with the one or more items, wherein the application is executed on a communication device.

17. The server computer of claim 1, wherein the primary payment account is a first primary payment account, the user is a first user and the virtual wallet is a first virtual wallet, and the method further comprises enrolling the information associated with the one or more items into a second virtual wallet associated with a second user, wherein the second virtual wallet includes information associated with a second primary payment account associated with the second user.

18. The server computer of claim 1, wherein the transaction message further comprises a primary payment account number associated with the primary payment account.

19. The server computer of claim 1, wherein the server computer is in a payment processing network, which resides between an acquirer and an issuer.

20. A system for enrolling one or more items into a virtual wallet, the system comprising:
a computer configured to implement a method comprising:
receiving, by the computer, a transaction message for a transaction, the transaction message including information associated with the one or more items; and
enrolling, by the computer, the information associated with the one or more items into the virtual wallet associated with a user, wherein the virtual wallet stores information associated with a primary payment account associated with the user; and
an access device in communication with the server computer.
